(19) United States
(12) Patent Application Publication
(10) Pub. No.: US 2014/0320254 A1
(43) Pub. Date: Oct. 30, 2014

(54) Assembly Having Transformer and Inductor Properties and Method of Making the Assembly

(71) Applicant: Nextek Power Systems, Inc., Detroit, MI (US)

(72) Inventors: Debabrato Kumar MONDAL, Detroit, MI (US); John H JAHSHAN, Northville, MI (US)

(73) Assignee: Nextek Power Systems, Inc., Detroit, MI (US)

(21) Appl. No.: 14/100,500

(22) Filed: Dec. 9, 2013

Related U.S. Application Data
(60) Provisional application No. 61/817,453, filed on Apr. 30, 2013.

(51) Int. Cl. H01F 27/28; H01F 41/06; H01F 27/24

(52) U.S. Cl. CPC H01F 27/28; H01F 27/24; H01F 41/06
USPC 336/220; 29/605

(57) ABSTRACT

An assembly having transformer and inductor characteristics includes a primary transformer winding coil and a secondary transformer winding coil, each wound around a core axis. The primary coil has outer peripheral primary coil portions spaced radially of the core axis outwardly away from central primary coil portions of the primary coil. The secondary coil has outer peripheral secondary coil portions spaced radially of the core axis outwardly away from central secondary coil portions of the secondary coil. The central primary and secondary coil portions are electromagnetically coupled and stacked in a close confronting adjacent relationship to form a transformer. The outer peripheral primary and secondary coil portions diverge radially and outwardly away from the core axis to form an inductance. The diverging outer peripheral primary and secondary coil portions bound an angle whose angular spread determines a magnitude of the inductance.

### CROSS-REFERENCE TO RELATED APPLICATION

This application claims the priority of U.S. provisional patent application Ser. No. 61/817,453, filed Apr. 30, 2013, the entire contents of which are hereby incorporated herein by reference thereto.

### FIELD OF THE DISCLOSURE

The present disclosure relates generally to an assembly having transformer and inductor properties and to a method of making the assembly and, more particularly, to an assembly having the properties and behavior of both a transformer and an inductor that are required for operation of a power converter, preferably a synchronous DC to DC power converter.

### BACKGROUND

Electrical transformers have been widely used to transfer electrical energy between a source and a load by employing a magnetic field which links the source and the load. Electrical transformers have been used for changing voltage, matching impedances and isolating circuits. For many of these applications, for example, in a synchronous DC to DC power converter, an inductor was required to ensure proper operation of the converter. It was therefore necessary to add a separate inductor to the converter. The separate inductor, however, added circuitry, weight, cost and complexity to the converter, and introduced losses that degraded the efficiency of the converter.

Accordingly, there is a need to eliminate the separate inductor, and to concomitantly reduce the overall circuitry, weight, cost and complexity, as well as to improve the overall efficiency, in such applications.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a partially broken-away, front perspective view of an assembly having transformer and inductor properties in accordance with this disclosure.

FIG. 2 is a top perspective view of the assembly of FIG. 1.

FIG. 3 is side elevational view of the assembly of FIG. 1, and depicting a divergence angle between outer primary and secondary transformer coil portions of the assembly.

FIG. 4 is a broken-away, enlarged, sectional view taken on line 4-4 of FIG. 2.

FIG. 5 is a graph depicting inductance versus the divergence angle between the outer primary and secondary transformer coil portions of the assembly of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The assembly and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In accordance with one feature of this invention, an assembly comprises a primary transformer winding coil and a secondary transformer winding coil, each wound around a core axis. The primary coil has outer peripheral primary coil portions spaced radially of the core axis outwardly away from central primary coil portions of the primary coil. The secondary coil has outer peripheral secondary coil portions spaced radially of the core axis outwardly away from central secondary coil portions of the secondary coil. The central primary and secondary coil portions are electromagnetically coupled and stacked in a close confronting adjacent relationship to form a transformer. The outer peripheral primary and secondary coil portions diverge radially and outwardly away from the core axis to form an inductance, especially a leakage inductance. The diverging outer peripheral primary and secondary coil portions bound an angle whose angular spread determines a magnitude of the inductance. The diverging outer peripheral primary and secondary coil portions create the leakage inductance of a sufficient magnitude to eliminate the prior art requirement for a separate inductor.

In accordance with another feature of this invention, a method of making an assembly is performed by winding a primary transformer winding coil around a core axis, by spacing outer peripheral primary coil portions of the primary coil radially of the core axis outwardly away from central primary coil portions of the primary coil, by winding a secondary transformer winding coil around the core axis, by spacing outer peripheral secondary coil portions of the secondary coil radially of the core axis outwardly away from central secondary coil portions of the secondary coil, by electromagnetically coupling and stacking the central primary and secondary coil portions in a close confronting adjacent relationship to form a transformer, and by diverging the outer peripheral primary and secondary coil portions radially and outwardly away from the core axis to form an inductance, especially a leakage inductance. The diverging outer peripheral primary and secondary coil portions bound an angle whose angular spread determines a magnitude of the inductance. The diverging outer peripheral primary and secondary coil portions create the leakage inductance of a sufficient magnitude to eliminate the prior art requirement for a separate inductor.

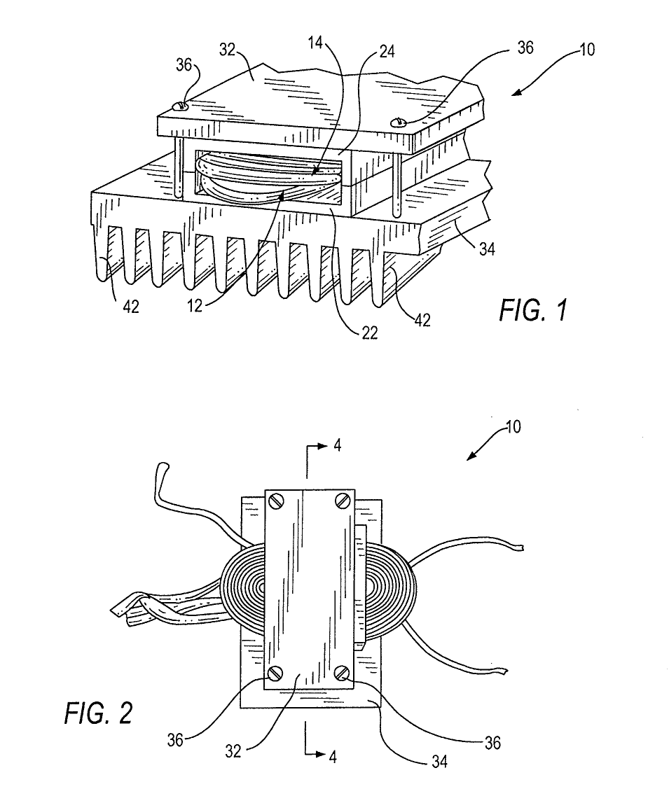

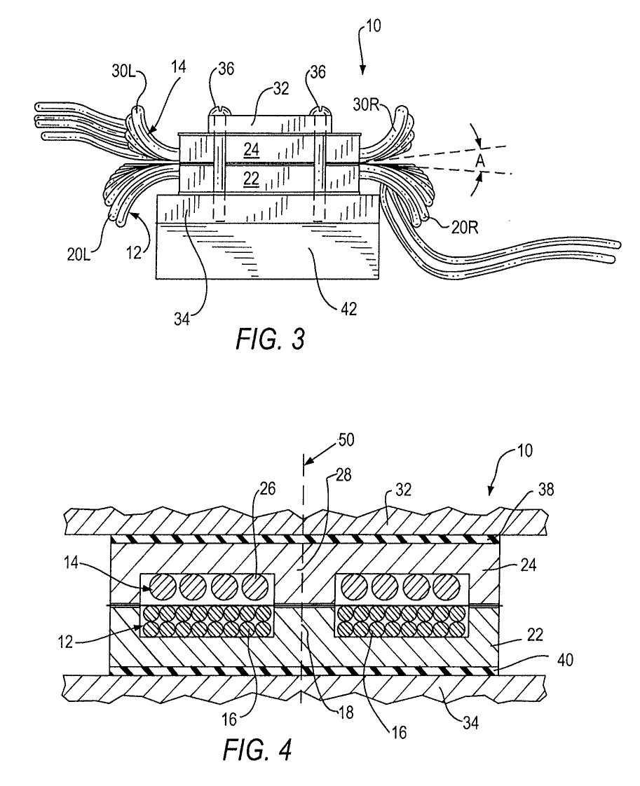

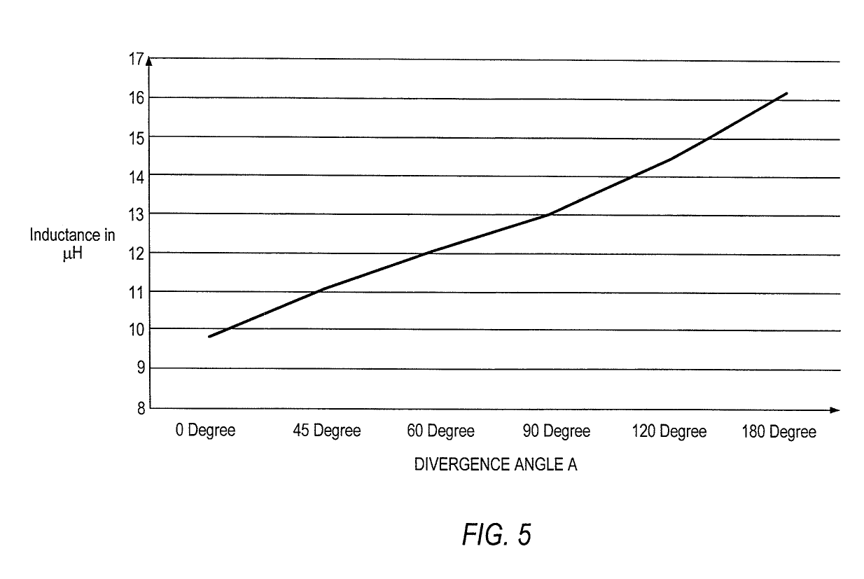

Turning now to the drawings, reference numeral 10 in FIG. 1 generally identifies an assembly having transformer and inductor properties. The assembly 10 comprises a primary transformer winding 12 and a secondary transformer winding 14. The primary winding 12 includes one primary wire coil, and preferably a pair of primary wire coils, each having central primary coil portions 16 (see FIG. 4) of wire wound around a primary core 18 that extends along a core axis 50, and outer peripheral primary coil portions 20L, 20R (see FIG. 3) of wire spaced radially of the core axis 50 outwardly away from the primary core 18. Each primary wire coil is an annulus, and is preferably shaped as an oval, and the outer peripheral primary coil portions 20L, 20R are located at opposite ends of a longer axis of the oval. The primary core 18 is made of a ferrite material and is centrally located in a primary plate 22.

The secondary winding 14 includes a secondary wire coil having central secondary coil portions 26 (see FIG. 4) of wire wound around a secondary core 28 that extends along the core axis 50, and outer peripheral secondary coil portions 30L, 30R (see FIG. 3) of wire spaced radially of the core axis 50 outwardly away from the secondary core 28. The secondary wire coil is an annulus, and is preferably shaped as an oval, and the outer peripheral primary coil portions 30L, 30R are located at opposite ends of a longer axis of the oval. The secondary core 28 is also made of a ferrite material and is centrally located in a secondary plate 24. The secondary core 28 is aligned with the primary core 18 along the core axis 50.

The assembly 10 further comprises a top plate 32 in surface area contact with the secondary plate 24, as well as a bottom plate 34 in surface area contact with the primary plate 22. Fasteners 36 extend between the top and bottom plates 32, 34 and fixedly secure the primary and secondary plates 22, 24 therebetween. Pads 38, 40 (see FIG. 4), preferably of rubber, are positioned between the top and bottom plates 32, 34 and the primary and secondary plates 22, 24. The bottom plate 34 is preferably made of a metal material to act as a heat sink and has heat-dissipating fins 42.

The central primary and secondary coil portions 16, 26 are electromagnetically coupled and stacked along the core axis 50 in a close confronting adjacent relationship to form a planar transformer. As best seen in FIG. 3, the outer peripheral primary and secondary coil portions 20R, 20L, 30R, 30L diverge radially and outwardly away from the core axis 50 along respective arcs to form an inductance, especially a leakage inductance. The diverging outer peripheral primary and secondary coil portions 20R, 30R, or 20L, 30L, or, more specifically, the tangents to the aforementioned arcs, bound an angle “A” whose angular spread determines a magnitude of the leakage inductance. FIG. 5 is a graph depicting the relationship between the leakage inductance (expressed in microhenries) and the divergence angle “A” (expressed in degrees). The greater the divergence angle, the greater the leakage inductance.

Although FIG. 3 depicts both the outer primary and secondary portions 20R, 30R as diverging apart at the same rate or extent, it is also contemplated that they could diverge at different rates or extents, and also that only one of these outer primary and secondary portions 20R, 30R diverges, while the other lies in a generally horizontal plane. The same is true for the outer primary and secondary portions 20L, 30L.

The resulting assembly integrates both a transformer's characteristics and an inductor's characteristics. Thus, the need for a separate, discrete inductor has been eliminated. In many applications, e.g., a synchronous DC to DC power converter, the overall circuitry, weight, cost and complexity has thus been reduced, and the overall efficiency has been improved.

A preferred method of making the assembly is performed as follows: To make the primary winding 12, a primary wire, preferably a Litz wire of 12 AWG, is wrapped in a generally horizontal plane around the primary core 18 for a number of turns, e.g., eight times, to form an oval. Then, the primary wire is moved to an outer edge of the primary core 18, and wrapped in a generally horizontal plane around the primary core 18 for an additional number of turns, e.g., eight more times, to form an oval. The opposite ends of this primary wire are then routed out of the assembly. To make the secondary winding 14, a secondary wire, preferably a Litz wire of the same or a different gauge as the primary wire, is wrapped in a generally horizontal plane around the secondary core 28 for a number of turns, e.g., eight times, to form an oval. The opposite ends of this secondary wire are then routed out of the assembly.

The pad 40 is placed on the bottom plate 34, and the primary plate 22 is then placed on the pad 40. The primary winding 12 can be coated with dielectric grease, and a Mylar strip may be placed over the Mylar-coated primary winding 12. Next, the secondary plate 24 is placed on top of the primary plate 22 such that the outer coil portions 20R, 30R overlap each other, and such that the outer coil portions 20L, 30L overlap each other. The pad 38 is placed on the secondary plate 24, and the top plate 32 is placed on top of the pad 38. Next, the fasteners 36 are tightened through predrilled holes in the plates to pull the top and bottom plates 32, 34 together, and secure the primary and secondary plates 22, 24 therebetween.

Next, one or more of the outer peripheral primary and secondary coil portions 20R, 30R, 20L, 30L are deformed or bent, preferably manually, to form the divergence angle “A”. In actual production, a jig will be used so that the outer peripheral primary and secondary coil portions 20R, 30R, 20L, 30L are deformed to the exact same divergence angle “A”. A varnish can be applied over the bent coil portions to help them in staying in the position to which they have been bent, especially in the presence of ambient heat.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, or contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An assembly having transformer and inductor characteristics, comprising:
a primary transformer winding coil wound around a core axis, the primary coil having outer peripheral primary coil portions spaced radially of the core axis outwardly away from central primary coil portions of the primary coil; and
a secondary transformer winding coil wound around the core axis, the secondary coil having outer peripheral secondary coil portions spaced radially of the core axis outwardly away from central secondary coil portions of the secondary coil;
wherein the central primary and secondary coil portions are electromagnetically coupled and stacked in a close confronting adjacent relationship to form a transformer,
wherein the outer peripheral primary and secondary coil portions diverge radially and outwardly away from the core axis to form an inductance; and
wherein the diverging outer peripheral primary and secondary coil portions bound an angle whose angular spread determines a magnitude of the inductance.

2. The assembly of claim 1, wherein each winding coil has an oval shape.

3. The assembly of claim 1, and a primary plate having a primary core around which the primary coil is wound, and a secondary plate having a secondary core around which the secondary coil is wound, and wherein the primary core and the secondary core are aligned and extend along the core axis.

4. The assembly of claim 3, wherein the outer peripheral primary and secondary coil portions extend away from the primary and secondary plates.

5. The assembly of claim 3, wherein one of the primary and secondary plates has heat-dissipating fins.

6. The assembly of claim 3, wherein the primary and secondary cores are constituted of a ferrite material.

7. The assembly of claim 1, wherein each coil is constituted of a Litz wire.

8. A method of making an assembly having transformer and inductor characteristics, comprising:
winding a primary transformer winding coil around a core axis, and spacing outer peripheral primary coil portions of the primary coil radially of the core axis outwardly away from central primary coil portions of the primary coil;
winding a secondary transformer winding coil around the core axis, and spacing outer peripheral secondary coil portions of the secondary coil radially of the core axis outwardly away from central secondary coil portions of the secondary coil;
electromagnetically coupling and stacking the central primary and secondary coil portions in a close confronting adjacent relationship to form a transformer; and
diverging the outer peripheral primary and secondary coil portions radially and outwardly away from the core axis to form an inductance, the diverging outer peripheral and secondary coil portions bounding an angle whose angular spread determines a magnitude of the inductance.

9. The method of claim 8, and winding each winding coil into an oval shape.

10. The method of claim 8, and winding the primary coil around a primary core on a primary plate, and winding the secondary coil around a secondary core on a secondary plate, and aligning the primary core and the secondary core to extend along the core axis.

11. The method of claim 10, and extending the outer peripheral primary and secondary coil portions away from the primary and secondary plates.

12. The method of claim 10, and configuring one of the primary and secondary plates with heat-dissipating fins.

13. The method of claim 10, and constituting the primary and secondary cores of a ferrite material.

14. The method of claim 8, and coating the diverging outer peripheral and secondary coil portions with a varnish to maintain the angular spread.

15. The method of claim 8, and winding each winding coil with a Litz wire.

16. The method of claim 8, wherein the diverging is manually performed.
